(19) United States
(12) Patent Application Publication
(10) Pub. No.: US 2026/0030054 A1
(43) Pub. Date: Jan. 29, 2026

(54) RUNTIME SCHEDULER QUEUE INTROSPECTION

(71) Applicant: SAP SE, Walldorf (DE)

(72) Inventors: Mathias Gottschlag, Altrip (DE); Niklas Opiela, Karlsruhe (DE)

(21) Appl. No.: 18/786,745

(22) Filed: Jul. 29, 2024

(51) Int. Cl. G06F 9/48

(52) U.S. Cl. CPC G06F 9/4881

(57) ABSTRACT

A system includes storage of job data describing a computing job in a job data location, creation of a queue entry associated with the computing job, the queue entry comprising a pointer to the job data location and a subset of the job data, storage of the queue entry in a job scheduler queue of a lock-free skiplist at a position based on a priority of the job, and reading of data from the queue entry and from a plurality of other queue entries of the job scheduler queue.

### BACKGROUND

Modern computing systems receive requests at increasingly high rates. The rates at which requests are received are expected to grow even further as the speeds of computing systems and network connections increase. Computing systems use schedulers to orchestrate the processing of received requests. For example, in a database system, a scheduler receives work packets, or jobs, and adds the jobs to a scheduler queue based on the respective priorities of the jobs. Threads retrieve and execute jobs from the scheduler queue based on the priority-based order of the jobs within the scheduler queue.

Poor system response time may be indicative of a code execution bottleneck. The contents of a scheduler queue may assist in determining where and why the bottleneck occurred. This assistance is limited due to the paucity of information typically included in the queue entries of a scheduler queue.

Reading the contents of a scheduler queue presents difficulties as well. Conventional scheduler queues do not allow unfettered access to their contents at runtime. These scheduler queues use a mutex or similar synchronization primitives to allow only exclusive access to the queue. Accordingly, a thread must exclusively lock access to the scheduler queue in order to read the contents of the scheduler queue. The entire system is potentially unresponsive during this time because new jobs cannot be added or removed from the scheduler queue while it is locked for reading.

What is needed are systems which facilitate efficient introspection of scheduler queue contents. Such systems may provide information in addition to the information which is commonly-present within a scheduler queue, and/or may allow introspection of logically-deleted queue entries.

### BRIEF DESCRIPTION OF THE DRAWINGS

FIG. 1 is a block diagram of a system providing scheduler queue introspection according to some embodiments.

FIG. 2A illustrates a lock-free skiplist including a plurality of queues and queue entries according to some embodiments.

FIG. 2B illustrates the lock-free skiplist of FIG. 2A after logical deletion of queue entries associated with a job according to some embodiments.

FIG. 3 is a flow diagram to add a job to a lock-free skiplist according to some embodiments.

FIG. 4 illustrates queue entries of a queue of a lock-free skiplist and corresponding job data to some embodiments.

FIG. 5 is a flow diagram to read data from a skiplist queue according to some embodiments.

FIG. 6 illustrates reading of queue entries of a queue of a lock-free skiplist according to some embodiments.

FIG. 7 is a block diagram of a non-uniform memory access architecture according to some embodiments.

FIG. 8 is a block diagram of a database system according to some embodiments.

FIG. 9 is a view of a cloud-based architecture according to some embodiments.

### DETAILED DESCRIPTION

The following description is provided to enable any person in the art to make and use the described embodiments. Various modifications will be readily apparent to those in the art.

Some embodiments provide iteration through a job scheduler queue to read all its contents, without the need to lock the queue from other simultaneous accesses to the queue. The job scheduler queue may be a queue of a lock-free priority-driven skiplist in some embodiments

A job scheduler queue according to some embodiments may incorporate memory reclamation schemes such as but not limited to Quiescent State Based Reclamation (QSBR) and Epoch Based Reclamation (EBR). A memory reclamation scheme frees memory which is no longer needed by a lock-free scheduler queue. The scheme also prevents queue entries from being deallocated while any thread may potentially access them.

Some embodiments provide a mechanism to iterate through queue entries, including logically-deleted but not deallocated queue entries, and present the contents thereof without the need to stop other accesses to the queue. Moreover, the mechanism may leverage the memory reclamation strategy to prevent the deallocation of any queue entries during the iteration through the queue.

According to some embodiments, the queue entries include job data describing the jobs associated therewith. The job data may include, for example, the type of the job, an ID of a system request from which the job was generated, and the ID of the thread that created the job. Conventionally, such job data may be deallocated from memory after it is retrieved by a thread, after which the job data would be inaccessible. Since the memory reclamation scheme prevents the queue entries of the scheduler queue from deallocation once a thread begins iterating through the queue entries, the job data stored therein is protected from deletion and can be read. Depending on the skiplist implementation, iterating through the skiplist may allow reading of queue entries that have been logically deleted but have not yet been completely unlinked from the skiplist. The availability of this job data at runtime may assist system debugging and monitoring.

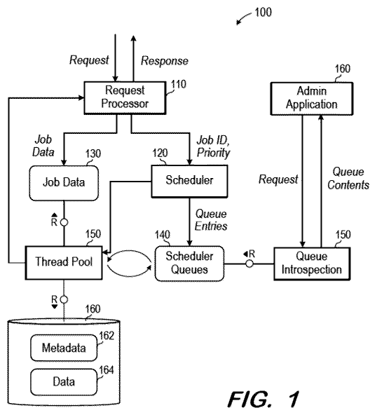

FIG. 1 is a block diagram of system 100 according to some embodiments. Each illustrated element of system 100 may be implemented using any suitable combination of computing hardware and/or software that is or becomes known. Such combinations may include on-premise servers, cloud-based servers, and/or elastically-allocated virtual machines. System 100 may comprise components of a standalone or distributed (i.e., multi-node) database system in some embodiments. Two or more elements of system 100 may be implemented by a single computing device. One or more elements of system 100 may be implemented as a cloud service (e.g., Software-as-a-Service, Platform-as-a-Service).

Request processor 110 receives requests. A request may comprise a database query or a request for another type of action which may be performed by system 100 (e.g., garbage collection, backup, statistics generation). According to some embodiments, request processor 110 is a component of a query processor which receives a query and generates a query execution plan and a pipeline execution order based on the received query.

Request processor 110 segments a received request into a plurality of different work packets (i.e., jobs). Request processor 110 also determines a job ID and an execution priority for each job. The jobs which are segmented from a single request may be associated with the same priority (e.g., all jobs are of priority 20) or with different priorities (e.g., one or more jobs are of priority 20, one or more other jobs are of priority 50, and one or more other jobs are of priority 5).

Request processor 110 also generates job data needed to execute each job and stores the job data in job data 130. The job data may include, for example, a reference to the code to be executed when the job is processed by a thread, the type of the job, an ID of a system request from which the job was generated, and the ID of the thread that created the job. The job data of a given job may be stored in job data 130 in association with a job ID of the given job to facilitate retrieval of the job data.

Scheduler 120 receives the job ID and the priority of each job from request processor 110. Scheduler 120 generates one or more queue entries for each job and places the queue entries in scheduler queues 140 based on the priorities of their respective jobs. Placement of queue entries into scheduler queues 140 according to some embodiments will be described in detail below. Scheduler queues 140 may simultaneously include queue entries associated with jobs of several different requests which were previously received by request processor 110. Scheduler queues 140 are queues of a lock-free skiplist according to some embodiments.

Scheduler queues 140 may be stored in shared memory accessible by multiple threads. The multiple threads may be threads of disparate CPU cores in some embodiments. The shared memory may comprise random-access memory, such as but not limited to DRAM, NVRAM, and Flash memory.

Thread pool 150 consists of available worker threads. By default, thread pool 150 includes one worker thread per logical CPU of system 100, but embodiments are not limited thereto. In some embodiments, the number of worker threads in the system is variable. For example, with the goals of maintaining high CPU utilization, a system may increase the total number of worker threads when, e.g., some threads sleep, wait for I/O, or perform other blocking system calls.

The threads of thread pool 150 retrieve queue entries of scheduler queues 140 based on their priority as will be described below. As illustrated, scheduler 120 may notify thread pool 150 in response to placement of new queue entries in scheduler queues 140.

Once a thread has retrieved a queue entry associated with a job from scheduler queue 140, the thread retrieves job data corresponding to the job from job data 130. The thread then executes the job based on the job data as is known in the art. Execution of the job may include reading and/or writing from/to data store 160.

Data store 160 may comprise any type of data storage system that is or becomes known. Data store 160 stores metadata 162 and data 164. Metadata 162 may comprise a database schema defining the structure and relationships of data stored in data 164. Data 164 may conform to any suitable formats, not limited to tabular data. Metadata 162 and data 164 may include metadata and data, respectively, of more than one tenant. This metadata and data may be physically, logically, and/or programmatically segregated to prevent one tenant from accessing the metadata or data of another tenant.

Threads of thread pool 150 return the results of executed jobs (which may have recursively created other jobs) to request processor 110. As is known in the art, request processor 110 generates responses to received requests based on the results of execution of the jobs of the requests. The responses are then returned to the requesting component.

According to some embodiments, scheduler queues 140 are managed using a memory reclamation scheme. According to EBR, the data structure of each thread includes a field for indicating that the thread is working on a lock-less data structure. This field indicates a current epoch of the thread in order to prevent freeing of any memory currently used by the thread.

A thread can only deallocate memory space if the current epoch of all other threads is greater than the global epoch at the time of the deletion. The global epoch is a global counter which is incremented from time-to-time (e.g., every n atomic operations), and is only incremented if all threads have reached the previous global epoch. For example, all threads can only be in one of two epochs at a given time, and the global epoch is only set to N+1 once all threads have reached epoch N. A thread that does not work on a lock-less data structure is flagged so that its epoch counter is ignored when incrementing the global epoch.

Queue introspection component 150 is executable to iterate over scheduler queues 140 and read the queue entries thereof. According to some embodiments, queue introspection component 150 sets a thread to the current epoch and uses the thread to read scheduler queues 140 without incrementing the current epoch of the thread. Due to the EBR scheme and the fixed epoch of the reading thread, any queue entries of scheduler queues 140 which are logically deleted by other threads during the reading of scheduler queues 140 are not deallocated even if the global epoch is incremented during the reading of scheduler queues 140.

Administrator application 160 may be operated by a system administrator to request the contents of scheduler queues 140 from queue introspection component 150. The queue contents may be used to assist debugging of system 100. Queue introspection component 150 may receive a request for the contents of scheduler queues 140 from any component, including services executing within system 100. For example, a service may request the queue contents from component 150 during generation of a memory dump in response to detection of a system crash, during collection of debugging information in response to non-fatal errors, etc.

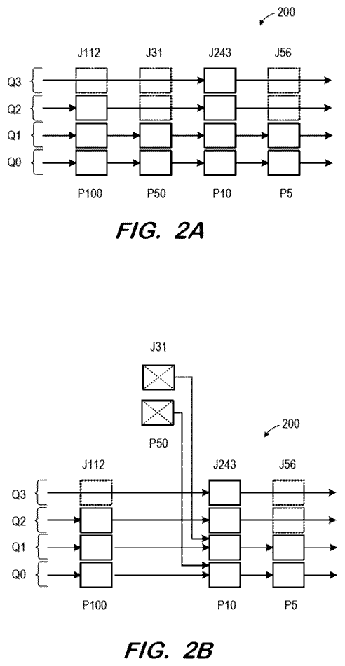

FIG. 2A illustrates lock-free skiplist 200 according to some embodiments. Skiplist 200 may comprise an implementation of scheduler queues 140 of FIG. 1. Skiplist 200 may be considered a probabilistic data structure that provides average complexity for search and average complexity for insertion within an ordered sequence of elements.

Skiplist 200 includes four queues Q0-Q3, but embodiments are not limited thereto. For example, a job executor skiplist may include approximately log(N) queues, where N is the expected maximum number of jobs. Each queue Q0-Q3 of skiplist 200 may include zero or more queue entries. Each queue entry of a queue includes a forward pointer to the next queue entry of the queue. Accordingly, each of queues Q0-Q3 is a linked list of queue entries. The solid rectangles of FIG. 2A represent queue entries which have been placed in respective queues, while the dashed rectangles depict memory which has been allocated for queue entries but which does not include a queue entry.

Skiplist 200 includes queue entries for jobs J112, J31, J243, and J56. Each vertical column of queue entries is associated with a single job. The queue entries of a job are inserted into skiplist 200 according to the priority of the job. The priority of job J31 is 50, so the queue entries of job J31 are inserted between the queue entries of job J112 (priority 100) and job J243 (priority 10).

Since each queue entry of a given vertical column belongs to a different queue, each queue entry of a given vertical column (i.e., job) includes a forward pointer to a different next queue entry. For example, the queue entry for job J112 in queue Q2 points to the queue entry for job J243 in queue Q2, the queue entry for job J112 in queue Q1 points to the queue entry for job J31 in queue Q1, and the queue entry for job J112 in queue Q0 points to the queue entry for job J31 in queue Q0.

The number of queue entries inserted into skiplist 200 for a given job (i.e., the height of the vertical column of queue entries representing the job) is variable. Generally, queue entries are inserted into skiplist 200 such that queue entry sparsity increases from the lowest queue (e.g., Q0) to the highest queue (e.g., Q3). This increasing sparsity facilitates fast determination of an insertion point for the queue entries of a new job.

For example, it is assumed that scheduler 120 receives job ID J518 representing a job having priority 15. Insertion of the job into skiplist 200 begins with examination of queue Q3. From left-to-right, the first queue interval of queue Q3 exists between a queue entry (unshown) representing infinite priority (i.e., a head of the queue) and a queue entry for job J243, representing priority 10. Since job J518 has priority 15, it is determined to insert job J518 somewhere between infinite priority and job J243.

Queue Q2 is then examined between a queue entry (unshown) representing infinite priority and its queue entry representing job J243. The first encountered interval in queue Q2 is between the queue entry representing infinite priority and a queue entry representing job J112. Since the priority of Job J112 is 100 and the priority of job J518 is 15, it is determined that job J518 should not be inserted between the queue entry representing infinite priority and the queue entry representing job J112. The next encountered interval in queue Q2 is between the queue entry representing job J112 and the queue entry representing job J243. Since the priority of Job J112 is 100 and the priority of job J243 is 10, it is determined that job J518 should be inserted somewhere between the queue entry representing job J112 and the queue entry representing job J243.

Next, queue Q1 is examined between its queue entry representing job J112 and its queue entry representing job J243. The first encountered interval in queue Q1 is between the queue entry representing job J112 and the queue entry representing job J31. Since the priority of Job J112 is 100 and the priority of job J31 is 50, it is determined that job J518 should not be inserted between the queue entry representing job J112 and the queue entry representing job J31. The next encountered interval in queue Q1 is between the queue entry representing job J31 and the queue entry representing job J243. Since the priority of Job J31 is 50 and the priority of job J243 is 10, it is determined that job J518 should be inserted somewhere between the queue entry representing Job J31 and the queue entry representing job J243.

Queue Q0 is examined between its queue entry representing job J31 and its queue entry representing job J24. Since only one interval exists between these entries, it is determined to insert job J518 between the queue entries of job J31 and the queue entries of job J24.

Insertion of queue entries into skiplist 200 includes a determination of a number of queues in which queue entries should be inserted. According to some embodiments, a queue entry for a job is always inserted into the lower-most queue (i.e., Q0). Insertion of queue entries into the other queues may follow a pseudo-random weighted determination. For example, the determination may conform to a 50% chance of inserting a queue entry into queue Q1, a 25% chance of inserting a queue entry into queue Q2, and a 12.5% chance of inserting a queue entry into queue Q3. Also according to some embodiments, a queue entry may be inserted into a particular queue only if queue entries are also inserted in all queues located below the particular queue.

Continuing the above example, it may be determined to insert one queue entry corresponding to job J518 into skiplist 200. Accordingly, the one queue entry is to be inserted in queue Q0 between the queue entry of job J31 and the queue entry of job J24. To insert the queue entry, the forward pointer of the queue Q0 queue entry which precedes the insertion point (i.e., the queue Q0 queue entry of job J31) is changed from the location of the queue Q0 queue entry of job J243 to the location of the queue Q0 queue entry of job J518. For example, the queue Q0 queue entry of job J31 is retrieved from its memory location, its forward pointer is changed as described above, and the changed queue entry is saved back to the memory location. These steps may occur atomically such that other threads accessing skiplist 200 in parallel always observe a consistent list state.

FIG. 2B represents deletion of the queue Q0 and Q1 queue entries of job J31 from skiplist 200. According to some embodiments, deletion of a queue entry occurs in two phases. First, in a logical deletion phase, a prior queue entry is marked to indicate that the next queue entry in the queue is to be deleted. Next, during a physical deletion phase, the pointer to the deleted entry in the prior queue entry is changed to the next undeleted entry in the queue. The “physically-deleted” queue entries are no longer within the linked list of their respective queue, but the queue entries remain at their memory locations. Moreover, the prior queue entry maintains the pointer to the deleted entry is so that the deleted entry can be located prior to its deallocation.

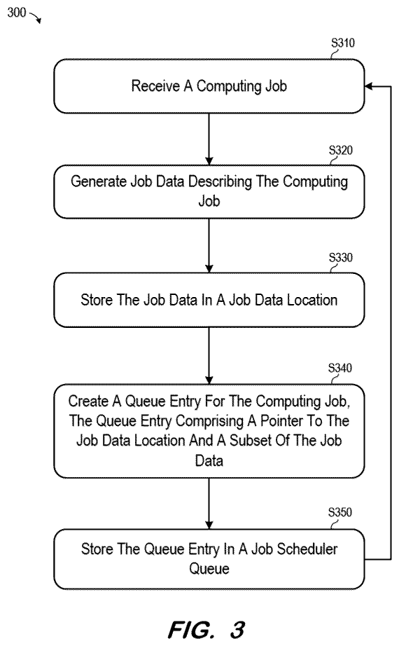

FIG. 3 comprises a flow diagram of process 300 according to some embodiments. In some embodiments, various hardware elements of system 100 execute program code to perform process 300. Process 300 and all other processes mentioned herein may be embodied in processor-executable program code read from one or more non-transitory computer-readable media, such as but not limited to a hard disk drive, a volatile or non-volatile random-access memory, a DVD-ROM, a Flash drive, and a magnetic tape, and which may be executed by one or more processing units, including but not limited to hardware processors, processor cores, and processor threads. Such processors, processor cores, and processor threads may be implemented by a virtual machine provisioned in a cloud-based architecture. In some embodiments, hard-wired circuitry may be used in place of, or in combination with, program code for implementation of processes according to some embodiments. Embodiments are therefore not limited to any specific combination of hardware and software.

Initially, at S310, a computing job is received. According to some embodiments, a request processor receives one or more requests and segments each of the one or more requests into one or more jobs as is known in the art. For each computing job, the request processor generates job data describing the job at S320. The generated job data is intended to provide enough information to allow a thread which accesses the job data to complete the job. According to some embodiments, the job data generated at S320 includes a reference to the code to be executed when the job is processed by a thread, the type of the job, an ID of a system request from which the job was generated, and the ID of the thread that created the job.

The job data is stored in a job data location at S330 such as, for example, an allocated memory location of job data 130 of system 100. Next, at S340, a queue entry is created for the job. The queue entry includes a pointer to the memory location of the job data of the job, and an indicator of the priority of the job. According to some embodiments, the queue entry also includes a subset of the job data. This subset may include, for example, the type of the job, an ID of a system request from which the job was generated, and the ID of the thread that created the job.

The queue entry is stored in a job scheduler queue at S350. As described above, the queue entry may be inserted at the location of the scheduler queue based on its priority relative to the priorities of other queue entries in the scheduler queue. If multiple scheduler queues are used, such as in a lock-free skiplist, a queue entry is created at S340 and stored at S350 for each queue into which queue entries for the job are to be inserted. Each queue entry created for a given job may be identical except for its forward pointer, which necessarily points to a next queue entry of its respective queue.

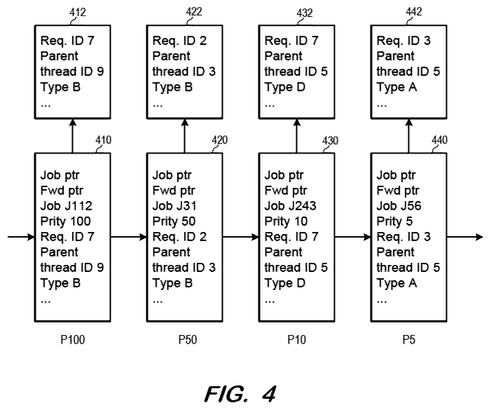

FIG. 4 illustrates queue entries 410, 420, 430, 440 of a queue of a lock-free skiplist and corresponding job data 412, 422, 432, 442 according to some embodiments. Each one of job data 412, 422, 432, 442 is stored in a respective memory location accessible by a pool of threads. Each of job data 412, 422, 432, 442 includes data usable by a thread to execute a corresponding job. As mentioned above, job data may include a reference to code, a request ID, a parent thread ID, a job type, and additional information, but embodiments are not limited thereto.

Each of queue entries 410, 420, 430, 440 includes a pointer (i.e., “Job ptr”) to a memory location storing job data of the job represented by the queue entry. Specifically, the job pointer of queue entry 410 points to a memory location of job data 412, the job pointer of queue entry 420 points to a memory location of job data 422, the job pointer of queue entry 430 points to a memory location of job data 432, and the job pointer of queue entry 440 points to a memory location of job data 442.

For the sake of clarity, it will be assumed that queue entries 410, 420, 430, 440 are entries of a lowest-level queue (e.g., queue Q0) of a skiplist which includes multiple queues. Accordingly, the jobs represented by each of queue entries 410, 420, 430, 440 may also be represented by one or more queue entries of the other queues of the skiplist as described above, and each of the one or more queue entries representing a given job includes a pointer to the memory location of the job data of the given job.

Each of queue entries 410, 420, 430, 440 includes a forward pointer to a next queue entry, a job ID, and a priority, and a pointer. Each of queue entries 410, 420, 430, 440 also includes a subset of the job data of its respective job. The subset includes a request ID, a parent thread ID, a job type, but embodiments are not limited thereto. In some embodiments, the queue entries of higher-level queues (e.g., queues Q1, Q2 . . . ) of the skiplist might not include the subsets of job data.

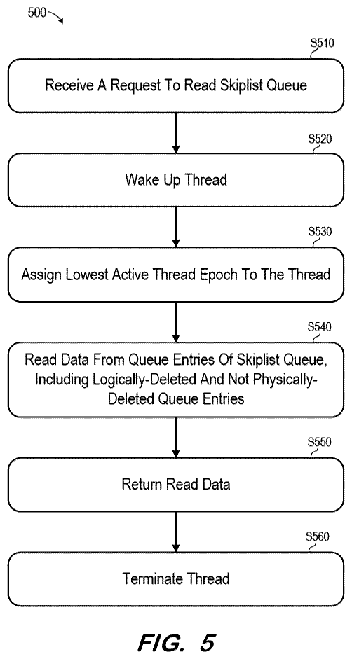

FIG. 5 illustrates flow diagram 500 to read data from a skiplist queue according to some embodiments. Initially, a request to read a skiplist queue is received at S510. The request may be received during runtime, while threads are simultaneously accessing the queue to retrieve queue entries, insert queue entries, and delete queue entries. Such access conforms to a memory reclamation scheme such as those described above.

In response to the request, a thread is woken up at S520. The thread may be an available sleeping thread of a thread pool. The thread is assigned the current global epoch (i.e., the highest epoch of any currently-active thread) at S530. Per the memory reclamation scheme of the queue, assigning the current global epoch to the thread ensures that no currently-existing queue entries will be deallocated until after the thread terminates. The epoch of the thread remains fixed (i.e., is not incremented) during process 500.

Next, at S540, data is read from the queue entries of the skiplist queue. According to some embodiments, the data is read from only the queue entries of the lowest-level queue of the skiplist queue, since this lowest-level queue includes a queue entry for each job of the queue. S540 includes reading of all deleted queue entries of the queue entries, including queue entries which are logically and/or “physically” deleted during S540 as described above.

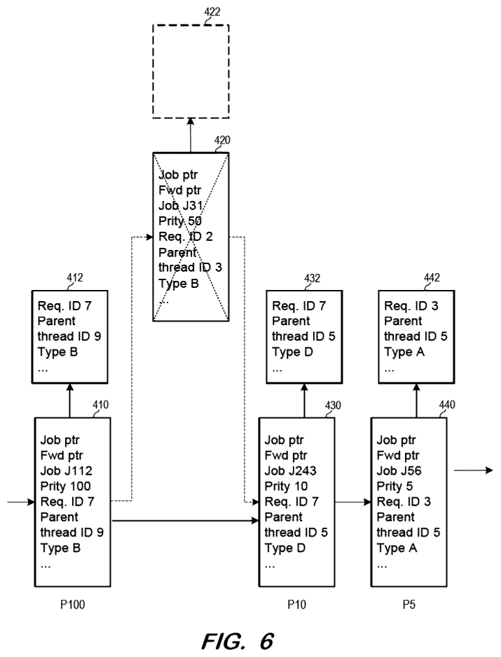

The data is read at S540 by iterating through the queue entries using their forward pointers. FIG. 6 illustrates queue entries 410, 420, 430 and 440 of FIG. 4. As shown, it will be assumed that queue entry 420 was deleted but not deallocated prior to or during S540. Although the memory reclamation strategy of the queue prevents deallocating of the memory location of queue entry 420 while the reading thread is active, corresponding job data 422 is not similarly protected and may be deallocated while the reading thread is active, as also shown. Nevertheless, a subset of job data 422 remains accessible and is read from queue entry 420.

The thread returns the data read from the queue entries at S550. The data may be displayed to a requesting user, included in a memory dump, and/or otherwise used. The thread may be terminated at S560, thereby allowing the epochs of active threads to advance and in turn allow deallocation of unneeded queue entries per the memory reclamation strategy. or just resets its EBR flag that indicates that it accesses the lock-free data structure.

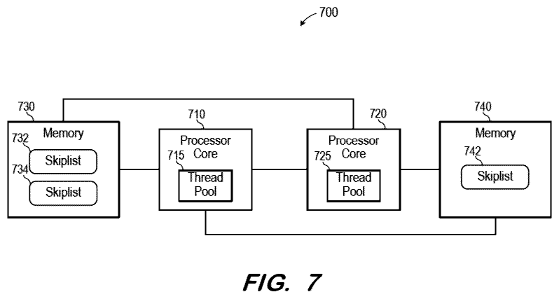

FIG. 7 is a block diagram of non-uniform memory access architecture 700 according to some embodiments. Architecture 700 includes processor cores 710 and 720, which may belong to the same CPU or to different CPUs. Each of processor cores 710 and 720 provides a respective one of thread pools 715, 725 including one or more execution threads.

According to some embodiments, processor core 710 is able to access volatile memory 730 directly coupled to processor core 710 and volatile memory 740 directly coupled to processor core 720. Similarly, processor core 720 is able to access volatile memory 730 directly coupled to processor core 710 and volatile memory 740 directly coupled to processor core 720.

Skiplist 732 of memory 730 may comprise a global skiplist accessible to threads of thread pool 715 and thread pool 725. Skiplist 734, on the other hand, may be reserved for jobs to be performed exclusively by threads of threads pool 715. Similarly, skiplist 742 of memory 740 may be reserved for jobs to be performed exclusively by threads of thread pool 725. The foregoing arrangement provides beneficial management of job execution. Any of skiplists 732, 734 and 742 may include queue entries including subsets of job data and suitable for reading at runtime as described above.

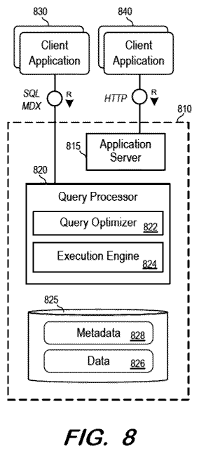

FIG. 8 is a block diagram of a database architecture which may support sub skiplist insertions according to some embodiments. Embodiments are not limited to the FIG. 8 architecture.

Server node 810 may receive a query from one of client applications 830 and 840 and return results thereto based on data stored within server node 810. Node 810 executes program code to provide application server 815 and query processor 820. Application server 815 provides services for executing server applications. For example, Web applications executing on application server 815 may receive Hypertext Transfer Protocol (HTTP) requests from client applications 840 as shown in FIG. 8.

Query processor 820 may include stored data and engines for processing the data. Query processor 820 may also be responsible for processing Structured Query Language (SQL) and Multi-Dimensional expression (MDX) statements and may receive such statements directly from client applications 830.

Query processor 820 includes query optimizer 822 for use in determining query execution plans and execution engine 824 for executing query execution plans against tables 826 of storage 825. Execution engine 824 may comprise a request processor and a scheduler to insert queue entries in skiplist queues and manage skiplist queues as described herein.

In some embodiments, the data of storage 825 may comprise one or more of conventional tabular data, row-stored data, column-stored data, and object-based data. Moreover, the data may be indexed and/or selectively replicated in an index to allow fast searching and retrieval thereof. Server node 810 may support multi-tenancy to separately support multiple unrelated clients by providing multiple logical database systems which are programmatically isolated from one another.

Metadata 828 includes data describing a database schema to which tables 826 confirm. Metadata 828 may therefore describe the columns and properties of tables 826, the properties of each column of each table 826, the interrelations between the columns, and any other suitable information. In one example, metadata 828 may identify one or more columns of tables 826 as dictionary-compressed and include information for locating the column dictionary and dictionary indices associated with each dictionary-compressed column.

Server node 810 may implement storage 825 as an “in-memory” database, in which a full database stored in volatile (e.g., non-disk-based) memory (e.g., Random Access Memory). The full database may be persisted in and/or backed up to fixed disks (not shown). Embodiments are not limited to an in-memory implementation. For example, data may be stored in random-access memory (e.g., cache memory for storing recently-used data) and one or more fixed disks (e.g., persistent memory for storing their respective portions of the full database).

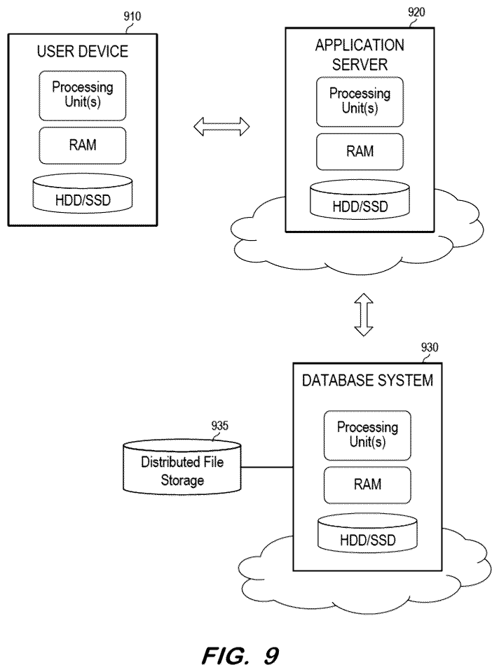

FIG. 9 illustrates a cloud-based database deployment according to some embodiments. The illustrated components may reside in one or more public clouds providing self-service and immediate provisioning, autoscaling, security, compliance and identity management features.

User device 910 may interact with applications executing on application server 920, for example via a Web Browser executing on user device 910, in order to create, read, update and delete data managed by database system 930 and persisted in distributed file storage 935. Database system 930 may store data and may execute processes as described herein to insert jobs into skiplists for execution by threads of database system 930. Application server 920 and/or database system 930 may comprise cloud-based compute resources, such as virtual machines, allocated by a public cloud provider. As such, application server 920 and database system 930 may exhibit demand-based elasticity.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation described herein may include a programmable processor to execute program code such that the computing device operates as described herein.

All systems and processes discussed herein may be embodied in program code stored on one or more non-transitory computer-readable media. Such media may include, for example, a DVD-ROM, a Flash drive, magnetic tape, and solid-state Random Access Memory or Read Only Memory storage units. Embodiments are therefore not limited to any specific combination of hardware and software.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

Embodiments described herein are solely for the purpose of illustration. Those in the art will recognize other embodiments may be practiced with modifications and alterations to that described above.

What is claimed is:

1. A system comprising:
a memory storing processor-executable program code; and
a processing unit to execute the processor-executable program code in order to cause the system to:
receive a computing job;
generate job data describing the computing job;
store the job data in a job data location;
create a queue entry associated with the computing job, the queue entry comprising a pointer to the job data location and a subset of the job data;
store the queue entry in a job scheduler queue; and
iterate over the job scheduler queue to read data from the queue entry and from a plurality of other queue entries of the job scheduler queue.

2. The system of claim 1, wherein queue entries of the job scheduler queue are managed using a memory reclamation scheme.

3. The system of claim 2, wherein the subset of the job data comprises a reference to executable code associated with the computing job.

4. The system of claim 2, wherein iteration over the job scheduler queue to read data from the queue entry and from a plurality of other queue entries of the job scheduler queue comprises:
reception of a request to read the job scheduler queue;
assignment of a current global epoch to an execution thread; and
reading of the data from the queue entry and from a plurality of other queue entries using the execution thread.

5. The system of claim 4, wherein the plurality of other queue entries of the job scheduler queue include logically-deleted queue entries.

6. The system of claim 1, wherein the plurality of other queue entries of the job scheduler queue include logically-deleted queue entries.

7. The system of claim 1, further comprising:
a second processing unit to cause the system to:
execute a first execution thread to logically delete one of the plurality of other queue entries from the job scheduler queue prior to reading of the data from the logically-deleted one of the plurality of other queue entries.

8. The system of claim 7, wherein iteration over the job scheduler queue to read data from the queue entry and from a plurality of other queue entries of the job scheduler queue comprises:
reception of a request to read the job scheduler queue;
assignment of a current global epoch to a second execution thread; and
reading of the data from the queue entry and from a plurality of other queue entries using the second execution thread.

9. The system of claim 1, wherein iteration over the job scheduler queue to read data from the queue entry and from a plurality of other queue entries of the job scheduler queue comprises:
reception of a request to read the job scheduler queue;
assignment of a current global epoch to an execution thread; and
reading of the data from the queue entry and from a plurality of other queue entries using the execution thread.

10. A method comprising:
storing job data describing a computing job in a job data location;
creating a queue entry associated with the computing job, the queue entry comprising a pointer to the job data location and a subset of the job data;
storing the queue entry in a job scheduler queue of a lock-free skiplist at a position based on a priority of the job; and
reading data from the queue entry and from a plurality of other queue entries of the job scheduler queue.

11. The method of claim 10, wherein queue entries of the job scheduler queue are deallocated based on a memory reclamation scheme.

12. The method of claim 11, wherein the subset of the job data comprises a reference to executable code associated with the computing job.

13. The method of claim 11, wherein reading data from the queue entry and from a plurality of other queue entries of the job scheduler queue comprises:
assigning a current global epoch to an execution thread; and
reading the data from the queue entry and from a plurality of other queue entries using the execution thread.

14. The method of claim 13, wherein the plurality of other queue entries of the job scheduler queue include logically-deleted queue entries.

15. The method of claim 10, wherein the plurality of other queue entries of the job scheduler queue include logically-deleted queue entries.

16. The method of claim 10, further comprising:
executing a first execution thread to logically delete one of the plurality of other queue entries from the job scheduler queue prior to reading of the data from the logically-deleted one of the plurality of other queue entries.

17. The method of claim 16, wherein reading data from the queue entry and from a plurality of other queue entries of the job scheduler queue comprises:
assigning a current global epoch to a second execution thread; and
reading the data from the queue entry and from a plurality of other queue entries using the second execution thread.

18. The method of claim 10, wherein reading data from the queue entry and from a plurality of other queue entries of the job scheduler queue comprises:
assigning a current global epoch to an execution thread; and
reading the data from the queue entry and from a plurality of other queue entries using the execution thread.

19. One or more non-transitory media storing processor-executable program code, the program code executable by a computing system to cause the computing system to:
store job data describing a computing job in a job data location;
create a queue entry associated with the computing job, the queue entry comprising a pointer to the job data location and a subset of the job data;
store the queue entry in a job scheduler queue of a lock-free skiplist at a position based on a priority of the job; and
read data from the queue entry and from a plurality of other queue entries of the job scheduler queue, wherein the plurality of other queue entries of the job scheduler queue include logically-deleted queue entries.

20. The one or more non-transitory media of claim 19, wherein reading of data from the queue entry and from a plurality of other queue entries of the job scheduler queue comprises:
assigning of a current global thread epoch to an execution thread; and
reading of the data from the queue entry and from a plurality of other queue entries using the execution thread.
